(19) United States
(12) Patent Application Publication
(10) Pub. No.: US 2017/0315263 A1
(43) Pub. Date: Nov. 2, 2017

(54) SYNCHRONIZING DOWNHOLE SUBS

(71) Applicant: HALLIBURTON ENERGY SERVICES, INC., Houston, TX (US)

(72) Inventors: Matthew C. Griffing, Kingwood, TX (US); Faisal F. Shah, Houston, TX (US); Brian A. Roberson, The Woodlands, TX (US); Randal T. Beste, Katy, TX (US)

(73) Assignee: HALLIBURTON ENERGY SERVICES, INC., Houston, TX (US)

(21) Appl. No.: 15/532,052

(22) PCT Filed: Dec. 31, 2014
(86) PCT No.: PCT/US2014/072991

§ 371 Date: May 31, 2017

(51) Int. Cl. G01V 13/00; G01V 3/28

(52) U.S. Cl. CPC G01V 13/00; G01V 3/28

(57) ABSTRACT

Systems for synchronizing downhole subs are disclosed. Some system embodiments may include a first downhole sub including a clock signal generator configured to generate an unmodified clock signal. The first downhole sub may also include a modification circuit configured to modify the clock signal. The system may also include a second downhole sub comprising a phase-locked loop circuit configured to receive as input the modified clock signal and output a second clock signal synchronous with the unmodified clock signal.

### BACKGROUND

Modern petroleum drilling and production operations demand a great quantity of information relating to the parameters and conditions downhole. Such information typically includes the location and orientation of the wellbore and drilling assembly, earth formation properties, and drilling environment parameters downhole. The collection of information relating to formation properties and conditions downhole is commonly referred to as “logging”, and can be performed during the drilling process itself.

Various measurement tools exist for use in wireline logging and logging while drilling. One such tool is the resistivity tool, which includes one or more antennas for transmitting an electromagnetic signal into the formation and one or more antennas for receiving a formation response. When operated at low frequencies, the resistivity tool may be called an “induction” tool, and at high frequencies it may be called an electromagnetic wave propagation tool. Though the physical phenomena that dominate the measurement may vary with frequency, the operating principles for the tool are consistent. In some cases, the amplitude and/or the phase of the receive signals are compared to the amplitude and/or phase of the transmit signals to measure the formation resistivity. In other cases, the amplitude and/or phase of the receive signals are compared to each other to measure the formation resistivity.

In the case of the resistivity tool, antennas may be located on different subs or modules. As such, one sub may transmit a signal into the formation while another sub receives a response from the formation. In this case, and other cases involving other downhole tools, it is preferable that the subs be precisely synchronized to enable their various operations to be tightly coordinated.

### BRIEF DESCRIPTION OF THE DRAWINGS

Accordingly, there are disclosed herein systems and methods for synchronizing downhole subs. In the following detailed description of the various disclosed embodiments, reference will be made to the accompanying drawings in which:

FIG. 1 is a contextual view of an illustrative logging while drilling environment;

FIG. 2 is a contextual view of an illustrative wireline logging environment;

FIG. 3 is an isometric view of an illustrative resistivity logging tool having multiple subs;

FIG. 4 is diagram showing coordinates for defining the orientation of a tilted antenna;

FIGS. 5A-5E are isometric views of illustrative extension subs for a geosteering tool assembly;

FIG. 6 is an isometric view of an illustrative geosteering tool assembly;

FIG. 7 is a block diagram of two illustrative subs being synchronized;

FIG. 8 is a block diagram of an illustrative phase-locked loop circuit for synchronizing two subs;

FIGS. 9-11 are block diagrams of two illustrative subs being synchronized; and

FIG. 12 is a flow diagram of an illustrative method of obtaining measurements using two synchronized subs.

It should be understood, however, that the specific embodiments given in the drawings and detailed description thereto do not limit the disclosure. On the contrary, they provide the foundation for one of ordinary skill to discern the alternative forms, equivalents, and modifications that are encompassed together with one or more of the given embodiments in the scope of the appended claims.

### Notation and Nomenclature

Certain terms are used throughout the following description and claims to refer to particular system components and configurations. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or a direct electrical connection. Thus, if a first device couples to a second device, that connection may be through a direct electrical connection, or through an indirect electrical connection via other devices and connections. In addition, the term “attached” is intended to mean either an indirect or a direct physical connection. Thus, if a first device attaches to a second device, that connection may be through a direct physical connection, or through an indirect physical connection via other devices and connections.

### DETAILED DESCRIPTION

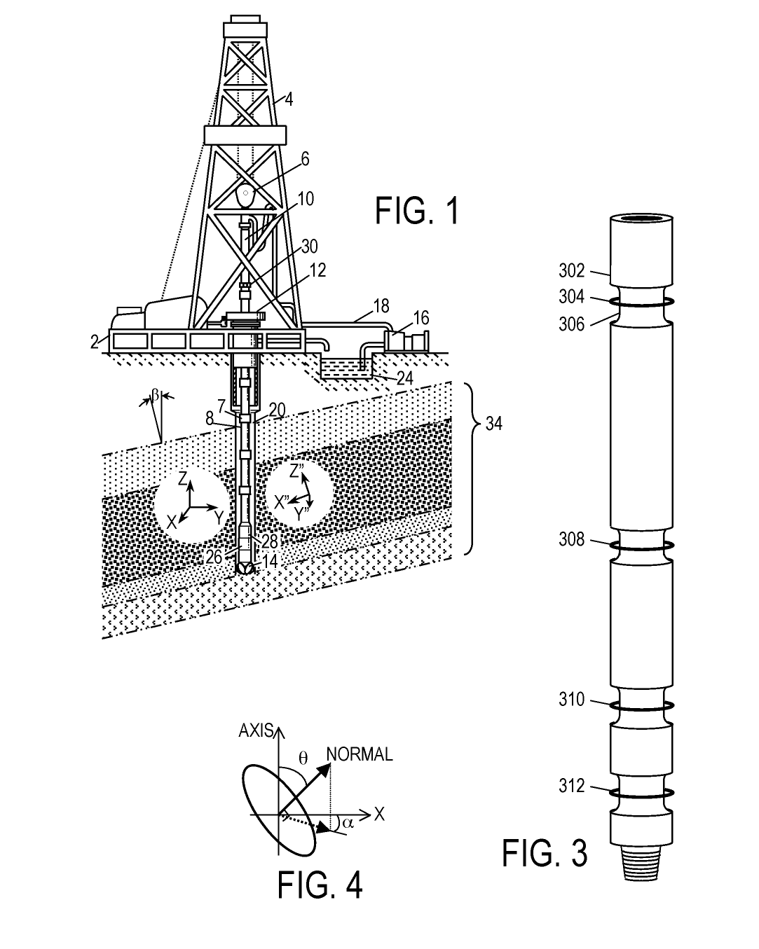

The issues identified in the background are at least partly addressed by systems and methods for synchronizing downhole subs. To illustrate a context for the disclosed systems and methods, FIG. 1 shows a well during drilling operations. A drilling platform 2 is equipped with a derrick 4 that supports a hoist 6. Drilling of oil and gas wells is carried out by a string of drill pipes connected together by “tool” joints 7 so as to form a drill string 8. The hoist 6 suspends a kelly 10 that lowers the drill string 8 through rotary table 12. Connected to the lower end of the drill string 8 is a drill bit 14. The bit 14 is rotated and drilling accomplished by rotating the drill string 8, by use of a downhole motor near the drill bit, or by both methods.

Drilling fluid, termed “mud”, is pumped by mud recirculation equipment 16 through supply pipe 18, through the kelly 10, and down through the drill string 8 at high pressures and volumes to emerge through nozzles or jets in the drill bit 14. The mud then travels back up the hole via the annulus formed between the exterior of the drill string 8 and the borehole wall 20, through a blowout preventer, and into a mud pit 24 on the surface. On the surface, the drilling mud is cleaned and then recirculated by recirculation equipment 16. For logging while drilling (LWD), downhole sensors 26 are located in the drillstring 8 near the drill bit 14. Sensors 26 include directional instrumentation and a modular resistivity tool with tilted antennas for detecting bed boundaries. The directional instrumentation measures the inclination angle, the horizontal angle, and the rotational angle (a.k.a. “tool face angle”) of the LWD tools. As is commonly defined in the art, the inclination angle is the deviation from vertically downward, the horizontal angle is the angle in a horizontal plane from true North, and the tool face angle is the orientation (rotational about the tool axis) angle from the high side of the well bore. In some embodiments, directional measurements are made as follows: a three axis accelerometer measures the earth's gravitational field vector relative to the tool axis and a point on the circumference of the tool called the “tool face scribe line”. (The tool face scribe line is drawn on the tool surface as a line parallel to the tool axis.) From this measurement, the inclination and tool face angle of the LWD tool can be determined. Additionally, a three axis magnetometer measures the earth's magnetic field vector in a similar manner. From the combined magnetometer and accelerometer data, the horizontal angle of the LWD tool can be determined. In addition, a gyroscope or other form of inertial sensor may be incorporated to perform position measurements and further refine the orientation measurements.

In some embodiments, downhole sensors 26 are coupled to a telemetry transmitter 28 that transmits telemetry signals by modulating the resistance to mud flow in drill string 8. A telemetry receiver 30 is coupled to the kelly 10 to receive transmitted telemetry signals. Other telemetry transmission techniques are well known and may be used. The receiver 30 communicates the telemetry to a surface installation that processes and stores the measurements. The surface installation typically includes a computer system, e.g. a desktop computer, which may be used to inform the driller of the relative position and distance between the drill bit and nearby bed boundaries.

The drill bit 14 is shown penetrating a formation having a series of layered beds 34 dipping at an angle. A first (x,y,z) coordinate system associated with the sensors 26 is shown, and a second coordinate system (x″,y″,z″) associated with the beds 32 is shown. The bed coordinate system has the z″ axis perpendicular to the bedding plane, has the y″ axis in a horizontal plane, and has the x″ axis pointing “downhill” The angle between the z-axes of the two coordinate systems is referred to as the “dip” and is shown in FIG. 1 as the angle β.

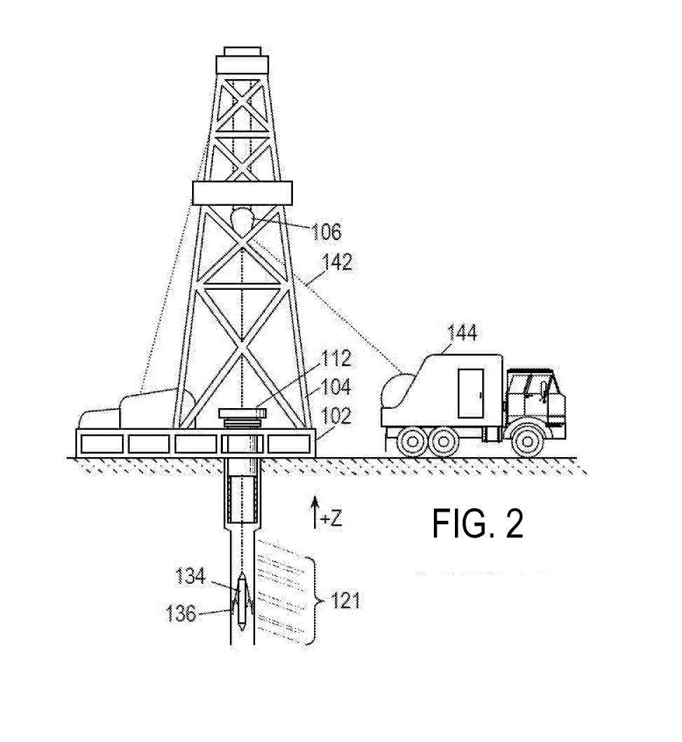

For a wireline environment, as shown in FIG. 2, a drilling platform 102 is equipped with a derrick 104 that supports a hoist 106. At various times during the drilling process, the drill string is removed from the borehole. Once the drill string has been removed, logging operations can be conducted using a wireline logging tool 134, i.e., a sensing instrument sonde suspended by a cable 142, run through the rotary table 112, having conductors for transporting power to the tool and telemetry from the tool to the surface. A multi-component induction logging portion of the logging tool 134 may have centralizing arms 136 that center the tool within the borehole as the tool is pulled uphole. A logging facility 144 collects measurements from the logging tool 134, and includes a processing system for processing and storing the measurements 121 gathered by the logging tool from the formation.

Referring now to FIG. 3, an illustrative base sub 302 is shown in the form of a resistivity tool. The base sub 302 is provided with one or more regions 306 of reduced diameter. A wire coil 304 is placed in the region 306 and spaced away from the surface of the base sub 302 by a constant distance. To mechanically support and protect the coil 304, a non-conductive filler material (not shown) such as epoxy, rubber, fiberglass, or ceramics may be used in the reduced diameter regions 306. The transmitter and receiver coils may comprise as little as one loop of wire, although more loops may provide additional signal power. The distance between the coils and the tool surface is preferably in the range from 1/16 inch to ¾ inch, but may be larger.

In the tool embodiment of FIG. 3, coils 304 and 308 are transmitter coils, and coils 310 and 312 are receiving coils. In operation, a transmitter coil 304 transmits an interrogating electromagnetic signal that propagates through the well bore and into the surrounding formation. Signals from the formation reach receiver coils 310, 312, inducing a signal voltage that is detected and measured to determine an amplitude attenuation and phase shift between coils 310 and 312. The measurement is repeated using transmitter 308. From the measured attenuation and phase shifts, the resistivity of the formation can be estimated using conventional techniques.

However, the illustrated base sub 302 lacks any azimuthal sensitivity, making it difficult to determine the direction of any approaching bed boundaries. Accordingly, it is desirable to tilt one or more of the antennas. FIG. 4 shows an antenna that lies within a plane having a normal vector at an angle of θ with the tool axis and at an azimuth of a with respect to the tool face scribe line. When θ equals zero, the antenna is said to be coaxial, and when θ is greater than zero the antenna is said to be tilted.

Though the illustrative base sub 302 does not include a tilted antenna, other base sub configurations are contemplated. For example, the base sub may include one or more tilted antennas to provide azimuthal sensitivity. It may include as little as one antenna (for transmitting or for receiving), or on the other extreme, it may be a fully self-contained geosteering and resistivity logging tool. When an extension sub is employed (as discussed below), at least one antenna in the base sub is expected to be employed for transmitting to a receiver on the extension sub or receiving from a transmitter on the extension sub. In this fashion, the extension sub extends the functionality of the base sub.

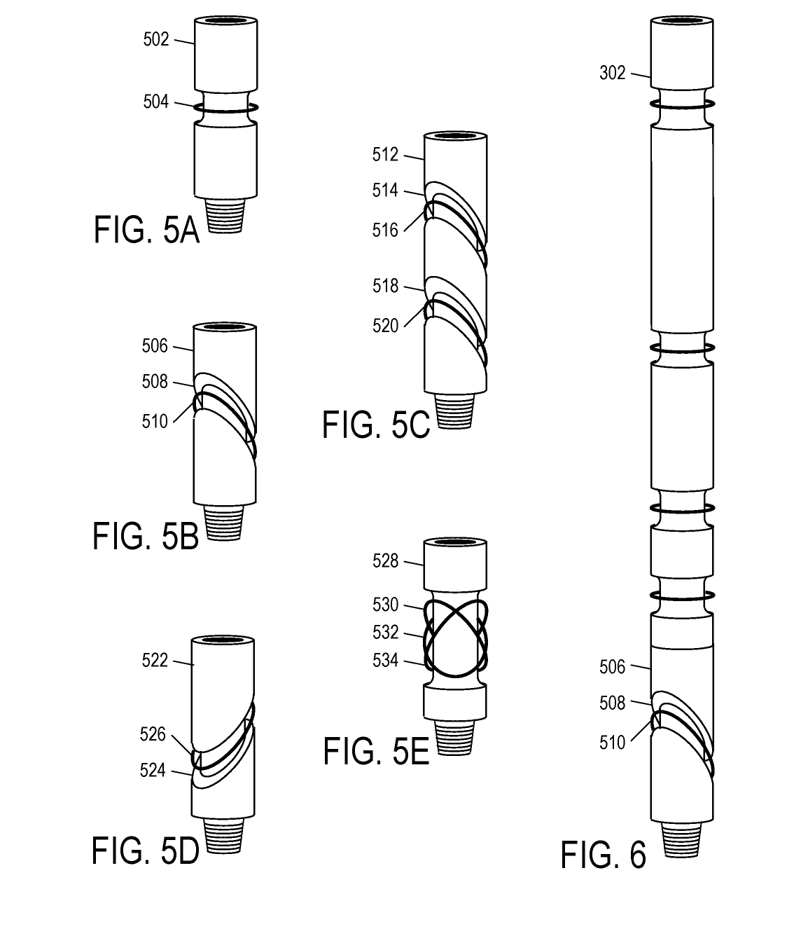

FIGS. 5A-5E illustrate various extension subs that may be added to a base sub such as downhole tool 302 (FIG. 3) to provide that tool with azimuthal sensitivity or other enhancements such as deeper resistivity measurements. In some alternative embodiments, these subs can also serve as base subs, enabling these subs to be mixed and matched to form a completely customized logging tool as needed for new logging techniques or geosteering techniques that are developed. As discussed further below, these subs may be provided with electronics that allow them to operate each antenna as a transmitter or a receiver. In some embodiments, a one-line power and communications bus (with the tool body acting as the ground) is provided to enable power transfer and digital communications between subs.

The resistivity tool subs have an attachment mechanism that enables each sub to be coupled to other subs. In some embodiments, the attachment mechanism may be a threaded pin and box mechanism as shown in FIGS. 5A-5E. In some other embodiments of the invention, the attachment means may be a screw-on mechanism, a press-fit mechanism, a weld, or some other attachment means that allows tool assemblies to be attached to other tool assemblies with controlled azimuthal alignments.

FIG. 5A shows an extension sub 502 having a coaxial antenna 504. FIG. 5B shows an extension sub 506 having an angled recess 508 containing a tilted antenna 510, thereby enabling azimuthally-sensitive resistivity measurements. Titled antenna 510 (and the recess 508) are preferably set at an angle of θ=45°. However, the tilted antenna 510 can be set at other angles in other embodiments. FIG. 5C shows an extension sub 512 having two angled recesses 514, 518 with respective tilted antennas 516 and 520. Providing multiple antennas in a single sub may enable tighter spacing requirements to be satisfied and may enable more accurate differential measurements to be performed.

FIG. 5D shows an extension sub 522 with a recess 524 and tilted antenna 526 at an azimuth 180° away from that of the antenna in FIG. 5B. Extension sub 522 may be designed to couple with the other subs in a manner that ensures this distinct alignment of antenna 526 relative to any other antennas such as those antennas in FIGS. 5B-5C. Alternatively, the extension subs may be provided with a coupling mechanism that enables the antennas to be fixed at any desired azimuthal alignment, thereby making subs 506 and 522 equivalent. As yet another alternative, a multi-axial antenna sub 528 may be provided as shown in FIG. 5E to enable virtual steering of the antenna alignment. Virtual steering involves the combination of measurements made by or with the different antennas 530, 532, and 534, to construct the measurement that would have been made by or with an antenna oriented at an arbitrary angle and azimuth.

As described above, each tool sub includes a recess around the external circumference of the tubular. An antenna is disposed within the recess in the tubular tool assembly, leaving no radial profile to hinder the placement of the tool string within the borehole. In some alternative embodiments, the antenna may be wound on a non-recessed segment of the tubular if desired, perhaps between protective wear bands.

FIG. 6 shows the base sub 302 of FIG. 3, coupled to an extension sub 506 having a tilted antenna 510 within a recess 508 to enable azimuthally sensitive resistivity measurements that can be used as part of a drillstring to provide geosteering with respect to nearby bed boundaries, or as part of a wireline tool string to provide enhanced resistivity measurements.

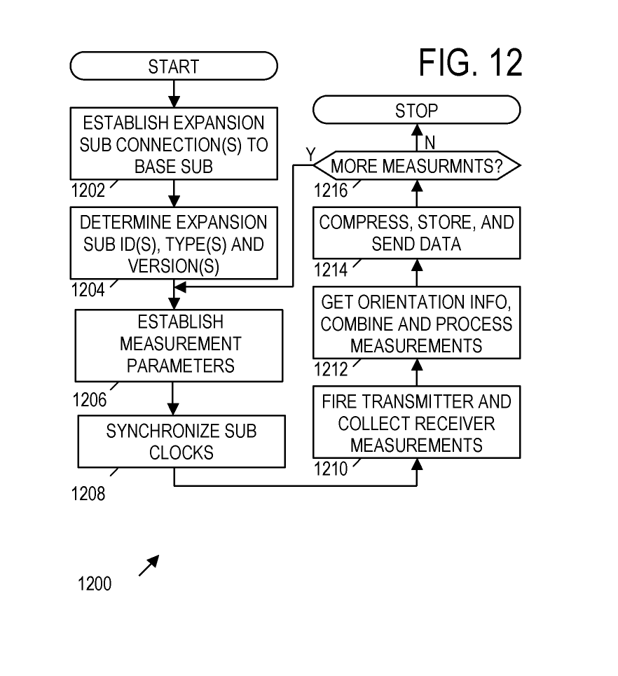

FIG. 12 is a flow diagram illustrating a method 1200 of obtaining measurements with two synchronized subs in a downhole tool assembly, e.g., the resistivity tool assembly of FIG. 6. At 1202, the one or more extension subs are coupled to the base sub. In some embodiments, the extension subs are threaded into the bottomhole assembly or tool string adjacent with the base sub, while in other embodiments, one or more intermediate tubulars and/or logging tools are positioned between or interspersed among the base sub and the one or more extension subs. Electrical contacts in the connectors establish the tool bus connections for internal conductor(s) that enable the subs to exchange electrical signals. Other suitable communication techniques may also be used.

At 1204, the base sub identifies each of the extension subs to which it is coupled. Each extension sub preferably includes a preprogrammed unique identifier, along with some indication of the sub type (e.g., transmitter, receiver, antenna orientation, and single or differential configuration) and version number to enable this identification process to be performed automatically by the base sub. However, custom configuration or programming by a field engineer can also be used as a method for setting up the tool.

At 1206, the base sub establishes the measurement parameters and communicates them to the relevant extension subs. For example, the measurement parameters may specify the transmitter antenna, the desired frequency and power setting, and the desired firing time. Where pulse signals are employed, the shape and duration of the pulse may also be specified.

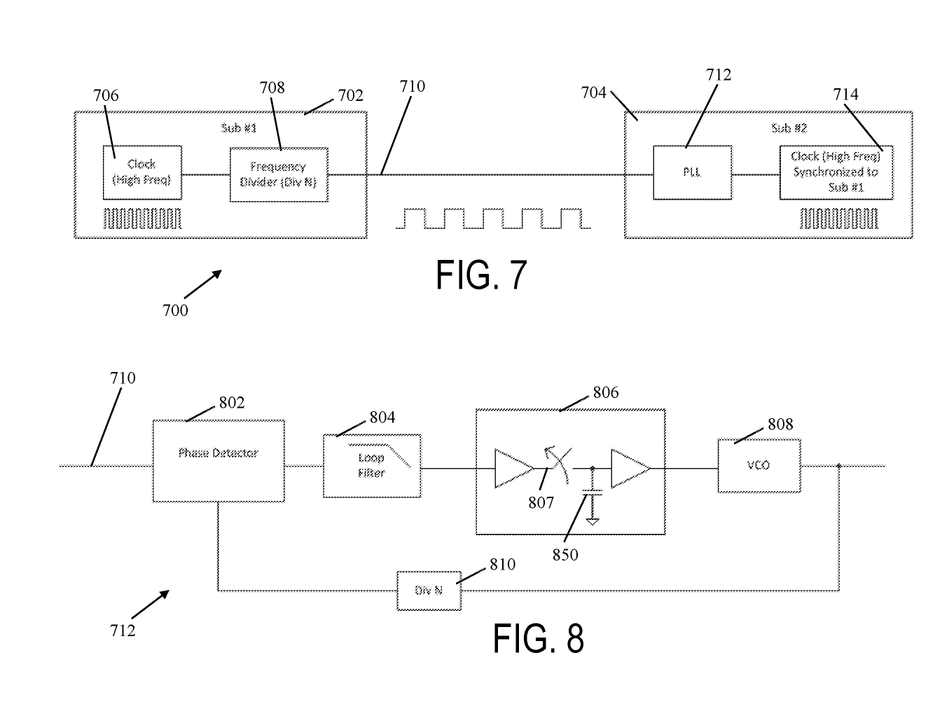

At 1208, the base sub initiates a clock synchronization procedure, as described below with respect to FIGS. 7-11, by entering the tool into a synchronization mode. To ensure measurement accuracy, the synchronization process may be repeated or refined before each measurement. As used herein, synchronization means full phase synchronization. As such, the base sub and extension sub also achieve synchronization of clock, frequency, time, etc. in addition to phase. Once the base sub and extension sub are synchronized, the tool may exit synchronization mode and enter a communication or measurement mode. Some alternative embodiments permit continuous synchronization in a separate frequency band or communications channel that coexists with other bus communications and operations of the tools.

At 1210, the transmitter fires and the receivers measure phase and attenuation. The base sub communicates with each of the extension subs to collect the receiver measurements. Where an extension sub transmitted the signal, an actual time of transmission may also be collected if that sub measured it.

At 1212, the base sub determines the tool orientation and processes the phase and attenuation measurements accordingly. In some embodiments, the tool rotates as it collects measurements. The measurements are sorted into azimuthal bins and combined with other measurements from that bin. Measurement error can be reduced by combining measurements in this fashion due to the effect of averaging. The base sub processes the measurements to determine azimuthal and radial dependence of the measurements, and may further generate a geosteering signal by taking the difference between measurements at opposite orientations or between the measurements for a given bin and the average of all bins.

At 1214, the base sub optionally compresses the data before storing it in internal memory and/or provides the data to the telemetry transmitter to be communicated to the surface. At 1216, the base sub determines if logging should continue, and if so, the operations repeat beginning at 1206.

FIG. 7 illustrates a system 700 synchronizing two subs 702, 704, such as the base sub and extension sub described with respect to FIG. 12. As used herein, synchronization means full phase synchronization. As such, the two subs 702, 704 also achieve synchronization of clock, frequency, time, etc. in addition to phase. The subs 702, 704 may be neighboring subs or may be separated by intervening subs in various embodiments. For clarity, synchronization of two subs 702, 704 will be discussed. However, any number of subs may be synchronized separately or simultaneously in various embodiments. A first sub 702 includes a clock 706 that generates a relatively high frequency clock signal. A clock signal oscillates between a high state and low state and is used to coordinate processes within the sub. For example, the clock signal may be a square wave, and processes may be coordinated on the rising edge, falling edge, or both edges of the square wave. The clock 706 may include a resonant circuit such as a piezoelectric oscillator and an amplifier circuit, and the clock 706 may be implemented as an individual circuit, integrated circuit, smaller portion of a larger circuit, and the like in various embodiments.

The first sub 708 also includes a frequency divider 708 coupled to the clock 706 in order to modify the clock signal. As illustrated, the frequency divider 708 is separate from the clock 706, but both may be implemented within the same circuit or hardware. The frequency divider 708 receives as input a clock signal having a frequency of F and outputs a clock signal having a frequency of F/N, wherein N is an integer. In at least some embodiments, fractional frequency dividers may be used, and N may be a fraction. The frequency divider 708 may be implemented as an individual circuit, integrated circuit, smaller portion of a larger circuit, and the like. In at least one embodiment, the frequency divider 708 is a direct digital synthesizer, which can generate multiple types of waveforms from the clock signal (generally a sinusoid). The direct digital synthesizer may change the type of waveform output based on changing conditions. For example, intermittent electromagnetic interference may cause one waveform (e.g., a sinusoid) to perform better than another (e.g., a square wave), and the direct digital synthesizer may switch between waveforms in response to the interference.

The frequency divider 708 outputs a relatively low frequency clock signal to a bus 710. In at least one embodiment, a coupling circuit is used to inject and receive signals on the bus 710. The bus 710 may be an inter-sub communication and power bus or a like bus that conveys communications and operations data between the subs 702, 704. The bus 710 may have a high attenuation at higher frequencies due to bus capacitance. As such, the range of signaling on the bus 710 may be limited to frequencies below those that would be ideal for synchronization. Accordingly, other communications and operations data may be halted during transmission of the low frequency clock signal in at least one embodiment. In another embodiment, the low frequency clock signal may be transmitted over the bus 710 using a dedicated frequency band while the communications and operations data are transmitted simultaneously using separate frequency bands.

The second sub 704 includes a phase-locked loop circuit 712, as will be described with respect to FIG. 8, coupled to a second clock 714. The phase-locked loop circuit 712 receives as input the low frequency clock signal from the bus 710 or coupling circuit and outputs a relatively high frequency signal. In at least one embodiment, this high frequency signal is a second clock signal that is synchronized with the signal generated by the first clock 706. As such, the second clock 714 may be omitted and the high frequency signal may be used directly as a clock signal for the second bus 704. In another embodiment, the high frequency signal is supplied to the second clock 714 as an input, and the second clock 714 generates a second clock signal based on the high frequency signal. The second clock signal is synchronized with the signal generated by the first clock 706. As such, the two clocks 706, 714 supply a synchronous clock signal to their respective subs 702, 704, and the subs 702, 704 are synchronized.

FIG. 8 illustrates a phase-locked loop circuit 712 including a phase detector 802, a loop filter 804, a track and hold circuit 806, sometimes synonymously referred to as a sample and hold (S/H) circuit, a voltage controlled oscillator 808, and a frequency divider 810 each of which may be implemented as an individual circuit, integrated circuit, and the like. The phase detector 802 receives as input the relatively low frequency clock signal from the bus 710. The phase detector 802 compares the feedback provided by the frequency divider 810 to the low frequency clock signal, and outputs a signal that represents the phase difference or error to the loop filter 804. The loop filter 804 is a low pass filter in at least one embodiment, and as such eliminates any relatively high frequencies from the signal supplied by the phase detector 802. Once filtered, the output of the loop filter 804 is supplied as input to the track and hold circuit 806.

The track and hold circuit 806 (or sample and hold) includes a switch 807, which may be mechanical, electronic/solid state, etc. in various embodiments, and one or more capacitors 809. In at least one embodiment, an electronic gate/buffer that can be disabled may be used as a switch. When the switch 807 is closed, the track and hold circuit 806, and consequently the phase-locked loop circuit 712, operates in track mode. Accordingly, the output of the track and hold circuit 806 “tracks” the output from the loop filter, i.e., the loop filter 804 supplies the voltage to the voltage-controlled oscillator 808 (VCO). The VCO 808 is an electronic oscillator whose oscillation frequency is controlled by a voltage input, i.e., the applied input voltage determines the instantaneous oscillation frequency. The signal output by the VCO 808 is a relatively high frequency signal that is provided to the frequency divider 810. Due to the feedback provided by the frequency divider 810, the phase detector 802 will continue to adjust the output of the VCO 808 until synchronization has been achieved.

Once synchronization is achieved, the switch 807 is opened and the track and hold circuit 806, and consequently the phase-locked loop circuit 712, operates in hold mode. Specifically, the track and hold circuit 806 “holds” the voltage at the VCO constant so that the relatively low frequency clock signal is no longer needed. If communications and operations data transmissions have been halted, those transmissions may resume in hold mode. The VCO 808 outputs a relatively high frequency signal until the voltage from the track and hold circuit 806 starts to droop due to, for example, capacitor discharge. How long the track and hold circuit 806 can hold the voltage is a function of the capacitor size, circuit impedance, and leakage of the circuit. For longer hold times, the capacitance and impedance values should be larger, and the leakage of the circuit should be minimized The hold time is inversely proportional to the number of synchronizations necessary, that is, a longer hold time results in fewer resynchronizations between subs 702, 704 over a given time period.

As illustrated, the capacitor 850 supplies the voltage to the VCO 808. In another embodiment, a digital-to-analog converter supplies the voltage to the VCO 808 during hold mode. Specifically, an analog-to-digital converter may be used to convert the voltage from the output of the loop filter 804 to a digital representation, and then a digital-to-analog converter may be used to recreate and output that same voltage to the VCO. This embodiment trades off complexity for the advantage of being able to hold the VCO input voltage indefinitely as the digital-to-analog converter would not suffer from drooping voltage over time.

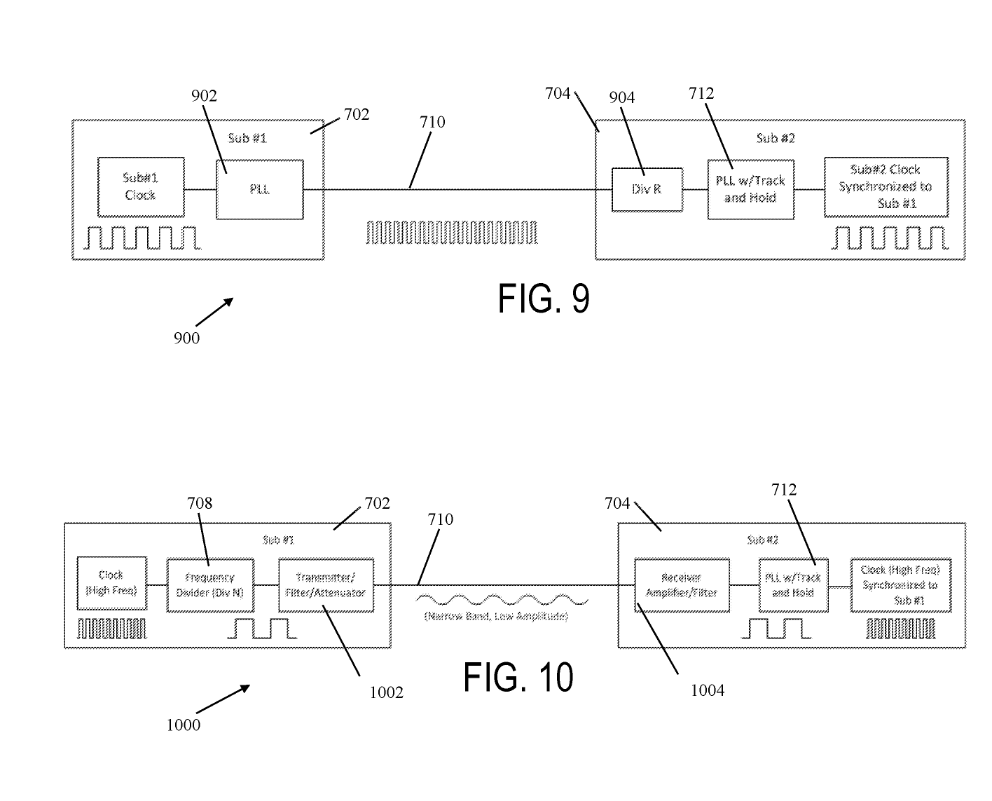

FIG. 9 illustrates a system 900 for modification of the first clock signal into a higher frequency signal for transmission over the bus 710 rather than a lower frequency signal. A higher frequency signal may be beneficial when, for example, the tool bus can support high frequency synchronization signals without adversely affecting normal tool bus operations. The first sub 702 includes a phase-locked loop circuit 902. The phase-locked loop circuit 902 receives as input a relatively lower frequency clock signal and outputs a relatively high frequency signal in phase with the input clock signal. The second sub 704 includes a second frequency divider 904 at the input of the phase-locked loop 712 to decrease the higher frequency clock signal received from the bus 710 to a relatively low frequency for input to the phase-locked loop circuit 712.

In general, frequency dividers may be added, or omitted, to achieve many combinations of clock frequencies in various embodiments. As discussed above, frequencies may be modified from relatively high to low to high again as the clock signal travels from one sub to another. Similarly, as discussed above, frequencies may be modified from relatively low to high to low again as the clock signal travels from one sub to another. However, the separate sub clocks may also be synchronized using the concepts disclosed herein even if different relative frequencies are used. For example, if the frequencies are modified from relatively high to low using only one frequency divider (on either sub) as the clock signal travels from one sub to another, or conversely from relatively low to high, the subs still may be synchronized using the concepts disclosed herein. Similarly, even if no frequency dividers are used and the frequency remains relatively high or low as the clock signal travels from one sub to another, the concepts disclosed herein may still be used to synchronize the two subs.

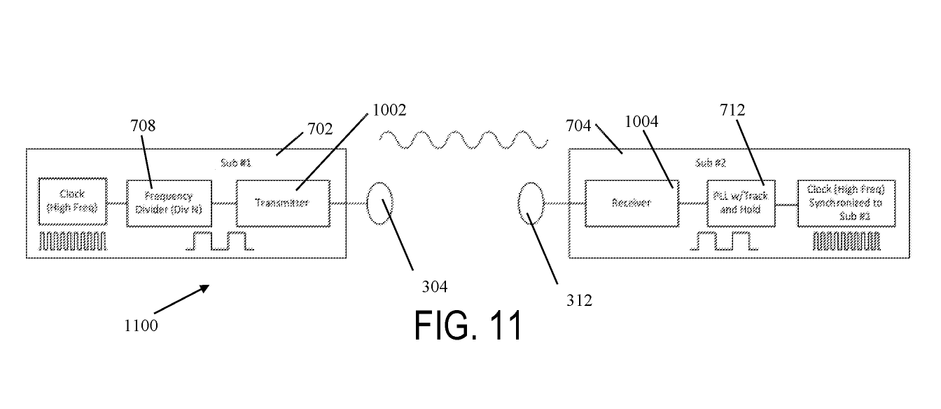

FIG. 10 illustrates a system 1000 for transmission of the clock signal in the form of a sinusoidal signal having a narrow band and low amplitude. The amplitude of the signal is below a threshold of amplitude that would interfere with downhole tool communications and operations in at least one embodiment. The first sub 702 includes a filter 1002 and/or attenuator that receives as input a relatively low frequency clock signal from the frequency divider 708 and outputs a sinusoidal signal having a low amplitude within a narrow band. The filter 1002 may be implemented in the transmitter that transmits the signal over the bus 710. The second sub 704 includes a filter 1004 and/or amplifier that receives as input the sinusoidal signal having a low amplitude within a narrow band and outputs a relatively low frequency square wave for input to the phase-locked loop circuit 712. The low amplitude and narrow band mitigates interference from communications and operations data on the bus 710 during transmission, and vice versa. As such, downhole tool communications and operations may continue uninterrupted while the subs 702, 704 actively synchronize with each other.

FIG. 11 illustrates a system 1100 for wireless transmission of the clock signal. The first sub 702 includes a transmitter 1002, including an antenna coil 304 such as those found on the downhole tool illustrated in FIG. 3, to receive the clock signal from the frequency divider 708 and transmit the clock signal. The second sub 704 includes a receiver 1004, including an antenna coil 312, to receive the clock signal and output a signal for the input of the phase-locked loop circuit 712. This embodiment may be used when there are no electrical connections between the subs 702, 704 or when a wireless connection would provide better efficiency, reliability, or the like.

The coil 304 may transmit the clock signal wirelessly through the earth formation in at least one embodiment Similarly, in other embodiments, the transmitter and receiver antennas, 304 and 312, may be a toroidal winding and the clock signal may be transmitted wirelessly through tool body, wellbore, toolbore, mud, and the like, as well as through the formation. The wirelessly transmitted clock signal may have a relatively low frequency because, as the spacing between the antenna coils 304, 312 increases, the useable frequency band may be increasingly skewed to the lower frequency range due to attenuation of higher frequencies in the formation.

A system includes: a first downhole sub including a clock signal generator configured to generate an unmodified clock signal. The first downhole sub also includes a modification circuit configured to modify the clock signal. The system also includes a second downhole sub comprising a phase-locked loop circuit configured to receive as input the modified clock signal and output a second clock signal synchronous with the unmodified clock signal. As used herein, synchronization means full phase synchronization. As such, the first downhole sub and second downhole sub also achieve synchronization of clock, frequency, time, etc. in addition to phase.

The phase-locked loop circuit may include voltage controlled oscillator coupled to a track and hold circuit (i.e. sample and hold). The track and hold circuit may include a switch (e.g. mechanical switch, electronic/solid state switch, etc.) configured to open when the second clock signal is synchronized with the unmodified clock signal. The phase-locked loop circuit may include a voltage controlled oscillator coupled to a digital-to-analog converter. The clock signal generator and modification circuit may be coupled by a switch (e.g. mechanical switch, electronic/solid state switch, etc.) configured to open when the second clock signal is synchronized with the unmodified clock signal. The switch may be implemented as an electronic gate/buffer that can be disabled. The modified clock signal is not transferred between the first downhole sub and the second downhole sub when the second clock signal is synchronized with the unmodified clock signal. The modification circuit may be a frequency divider. The modification circuit may be a second phase-locked loop circuit. The modified clock signal may be a sinusoidal signal having a narrow band and low amplitude. The modified clock signal may be transmitted wirelessly through a downhole formation, tool body, wellbore, toolbore, mud, etc. in various embodiments. The first downhole sub and second downhole sub may be coupled through one or more intervening downhole subs.

A circuit includes: a phase detector configured to receive a modified clock signal modified from an unmodified clock signal. The circuit also includes a voltage controlled oscillator configured to output a clock signal synchronous with the unmodified clock signal. The circuit also includes a track and hold circuit including a switch configured to open when the clock signal is synchronized with the unmodified clock signal.

The track and hold circuit may supply the voltage controlled oscillator with a constant voltage while the switch is open. The switch may close when the constant voltage cannot be supplied. The track and hold circuit may include a capacitor that supplies the constant voltage. The track and hold circuit may include a digital-to-analog converter that supplies the constant voltage. The phase detector may receive the modified clock signal from a communication bus. The phase detector may receive the modified clock signal from a power bus.

A method of synchronizing two downhole subs, includes: conveying a tool comprising a base sub and an extension sub along a borehole; generating, at the base sub, an unmodified clock signal; modifying, at the base sub, the unmodified clock signal to create a modified clock signal; sending, from the base sub, the modified clock signal to the extension sub during a synchronization mode of the tool; acquiring, at the extension sub, the modified clock signal and synchronizing a second clock signal with the unmodified clock signal based on the modified clock signal.

The method may further include ceasing the synchronization mode and beginning a communications mode of the tool.

While the present disclosure has been described with respect to a limited number of embodiments, those skilled in the art will appreciate numerous modifications and variations therefrom. It is intended that the appended claims cover all such modifications and variations.

What is claimed is:

1. A system for synchronizing two downhole subs, comprising:
a first downhole sub, comprising:
a clock signal generator configured to generate an unmodified clock signal; and
a modification circuit configured to modify the clock signal;
a second downhole sub comprising a phase-locked loop circuit configured to receive as input the modified clock signal and output a second clock signal synchronous with the unmodified clock signal.

2. The system of claim 1, wherein the phase-locked loop circuit comprises a voltage controlled oscillator coupled to a track and hold circuit.

3. The system of claim 2, wherein the track and hold circuit comprises a switch configured to open when the second clock signal is synchronized with the unmodified clock signal.

4. The system of claim 1, wherein the phase-locked loop circuit comprises a voltage controlled oscillator coupled to a digital-to-analog converter.

5. The system of claim 1, wherein the clock signal generator and modification circuit are coupled by a switch configured to open when the second clock signal is synchronized with the unmodified clock signal.

6. The system of claim 1, wherein the modified clock signal is not transferred between the first downhole sub and the second downhole sub when the second clock signal is synchronized with the unmodified clock signal.

7. The system of claim 1, wherein the modification circuit is a frequency divider.

8. The system of claim 1, wherein the modification circuit is a second phase-locked loop circuit.

9. The system of claim 1, wherein the modified clock signal is a sinusoidal signal having a narrow band and low amplitude.

10. The system of claim 1, wherein the modified clock signal is transmitted wirelessly through a downhole formation.

11. The system of claim 1 wherein the first downhole sub and second downhole sub are coupled through one or more intervening downhole subs.

12. A circuit for synchronizing two downhole subs, comprising:
a phase detector configured to receive a modified clock signal modified from an unmodified clock signal;
a voltage controlled oscillator configured to output a clock signal synchronous with the unmodified clock signal; and
a track and hold circuit comprising a switch configured to open when the clock signal is synchronized with the unmodified clock signal.

13. The circuit of claim 12, wherein the track and hold circuit is configured to supply the voltage controlled oscillator with a constant voltage while the switch is open.

14. The circuit of claim 13, wherein the switch is configured to close when the constant voltage cannot be supplied.

15. The circuit of claim 13, wherein the track and hold circuit comprises a capacitor configured to supply the constant voltage.

16. The circuit of claim 13, wherein the track and hold circuit comprises a digital-to-analog converter configured to supply the constant voltage.

17. The circuit of claim 12, wherein the phase detector is configured to receive the modified clock signal from a communication and power bus with dedicated frequency band for clock signals.

18. A method of synchronizing two downhole subs, comprising:
conveying a tool comprising a base sub and an extension sub along a borehole;
generating, at the base sub, an unmodified clock signal;
modifying, at the base sub, the unmodified clock signal to create a modified clock signal;
sending, from the base sub, the modified clock signal to the extension sub during a synchronization mode of the tool; and
acquiring, at the extension sub, the modified clock signal and synchronizing a second clock signal with the unmodified clock signal based on the modified clock signal.

19. The method of claim 18, further comprising ceasing the synchronization mode and beginning a communications mode of the tool.

20. A system for synchronizing two downhole subs, comprising:
a first downhole sub, comprising:
a clock signal generator configured to generate a clock signal; and
a second downhole sub comprising a phase-locked loop circuit, comprising a track and hold sub-circuit, configured to receive as input the clock signal and output a second clock signal synchronous with the clock signal.
